(19) United States
(12) Patent Application Publication
(10) Pub. No.: US 2021/0209474 A1
(43) Pub. Date: Jul. 8, 2021

(54) COMPRESSION METHOD AND SYSTEM FOR FREQUENT TRANSMISSION OF DEEP NEURAL NETWORK

(71) Applicant: PEKING UNIVERSITY, Beijing (CN)

(72) Inventors: Lingyu DUAN, Beijing (CN); Ziqian CHEN, Beijing (CN); Yihang LOU, Beijing (CN); Tiejun HUANG, Beijing (CN)

(73) Assignee: PEKING UNIVERSITY, Beijing (CN)

(21) Appl. No.: 17/057,882

(22) PCT Filed: Apr. 12, 2019
(86) PCT No.: PCT/CN2019/082384

§ 371 Date: Nov. 23, 2020

(30) Foreign Application Priority Data
May 29, 2018 (CN) 201810528239.4

(51) Int. Cl. G06N 3/08; G06N 3/04

(52) U.S. Cl. CPC G06N 3/082; G06N 3/04

(57) ABSTRACT

Disclosed are a compression method and system for the frequent transmission of a deep neural network. The deep neural network compression is extended to the field of transmission, and the potential redundancy among deep neural network models is utilized for compressing, so that the overhead of the deep neural network under frequency transmission is reduced. The advantages of the present invention are that: in the present invention, the redundancy among multiple models of the deep neural network on the frequency transmission is combined, knowledge information among deep neural networks is utilized for compressing, and the size and the bandwidth of the required transmission are reduced. The deep neural network can be better transmitted under the same bandwidth limitation; meanwhile, the deep neural network is allowed to be performed targeted compression at a front end, rather than being restored partially after being performed targeted compression.

### TECHNICAL FIELD

The present invention belongs to the technical field of artificial intelligence, and specifically relates to a compression method and a compression system for frequent transmission of a deep neural network.

### BACKGROUND

With the development of artificial intelligence, deep neural networks have demonstrated powerful capabilities and achieved excellent results in various fields, and various deep neural network models are continuing to develop, achieving widespread propagation and development in the network. However, with the development of deep neural networks, the enormous computing resources and storage overhead required for operations thereof have also attracted much attention. Therefore, in respect of the problem of how to reduce the volume and computing power of deep neural networks while maintaining the powerful performance of deep neural networks, many methods for compressing deep neural networks have been proposed. For example, by adopting methods such as network pruning, singular value decomposition, binary deep neural network construction, knowledge distillation, etc., and in combination with quantization, Huffman coding, etc., the deep neural network can be compressed to a certain extent so that a lightweight network can be formed. Most methods perform compression for a certain given task and retrain the original network, in which the compression takes a long time, and it is not necessarily possible to decompress the compressed network.

FIG. 1 shows an algorithm for traditional compression of deep neural networks. As shown in FIG. 1, traditional deep neural networks optionally adopt data-driven or non-data-driven methods. For deep neural networks, different algorithms such as pruning, low-rank decomposition, selection of convolution kernel, model reconstruction, etc. are used (or not used) to generate a preliminarily compressed deep neural network model, then knowledge transfer or retraining is optionally adopted, and the above process is repeated to finally generate a preliminarily compressed deep neural network model. At the same time, the preliminarily compressed deep neural network model cannot be decompressed and restored back to the original network model to a large extent.

After the preliminarily compressed deep neural network model is obtained, optionally, the network model is quantized in a quantizing manner, and then optionally, the deep neural network is encoded in an encoding manner to finally generate an encoded quantized deep neural network model.

FIG. 2 shows a schematic flowchart of applying the method for traditional compression of deep neural networks to network transmission. As shown in FIG. 2, the deep neural network is compressed based on the current traditional deep network compression from the perspective of a single model, which is sorted into a single-model compression method. Optionally, the original network can be compressed by a way of quantizing or encoding, and the encoded compressed deep neural network can be transmitted. At a decoding end, after the received encoded compression model is decoded, a quantized compressed deep neural network can be obtained.

However, all the current methods are developed from the perspective of “reducing the storage overhead and computing overhead of deep neural networks”. However, with the frequent updates of deep neural networks and frequent transmission over the network, the transmission overhead brought by deep neural networks is also an urgent problem to be solved. It is a feasible way to indirectly reduce the transmission overhead by reducing the storage size. However, in the face of a wider range of conditions for frequent transmission of deep neural networks, a method that can compress the deep neural networks in the transmission stage is required so that the model can be compressed efficiently at a transmitting end, and the transmitted compressed model can be decompressed at a receiving end, thereby maintaining attributes of the original deep neural networks to the greatest extent. For example, when the bandwidth is limited but the storage size of the receiving end is not considered, if the deep neural network models are received frequently at the receiving end, a compression method and a compression system for transmission of deep neural networks need to be proposed.

### SUMMARY

In view of the high bandwidth overhead under frequent transmission of deep neural networks, the present invention provides a compression method and system for frequent transmission of deep neural networks, in which deep neural network compression is extended to the field of transmission, and the potential redundancy among deep neural network models is utilized for compression, so that the overhead of deep neural networks under frequent transmission is reduced, that is, multiple models under frequent transmission are used for compression.

According to an aspect of the present invention, a compression method for frequent transmission of a deep neural network is provided, which includes:

based on one or more deep neural network models of this and historical transmissions, combining part or all of model differences between part or all of models to be transmitted and models of the historical transmissions to generate one or more predicted residuals, and transmitting information required for relevant predictions; and

generating a received deep neural network based on the received one or more quantized predicted residuals and in combination with deep neural networks stored at a receiving end, including replacing or accumulating the originally stored deep neural network models.

Preferably, the method specifically includes: sending, by a transmitting end, a deep neural network to be transmitted to a compression end so that the compression end obtains data information and organization manner of one or more deep neural networks to be transmitted;

based on the one or more deep neural network models of this and historical transmissions, performing model prediction compression of multiple transmissions by a prediction module at the compression end to generate predicted residuals of the one or more deep neural networks to be transmitted;

based on the generated one or more predicted residuals, quantizing the predicted residuals by a quantization module at the compression end in one or more quantizing manners to generate one or more quantized predicted residuals;

based on the one or more generated quantized predicted residuals, encoding the quantized predicted residuals by an encoding module at the compression end using an encoding method to generate one or more encoded predicted residuals and transmit them;

receiving the one or more encoded predicted residuals by a decompression end, and decoding the encoded predicted residuals by a decompression module at the decompression end using a corresponding decoding method to generate one or more quantized predicted residuals; and

generating, by a model prediction decompression module at the decompression end, a received deep neural network at the receiving end based on the one or more quantized predicted residuals and the deep neural network stored at the receiving end for the last time by means of multi-model prediction.

Preferably, the data information and organization manner of the deep neural networks include data and network structure of part or all of the deep neural networks.

Preferably, in an environment where the compression end is based on frequent transmission, the data information and organization manner of the one or more deep neural network models of the historical transmissions of the corresponding receiving end can be obtained; and if there is no deep neural network model of the historical transmissions, an empty model is set as a default historical transmission model.

Preferably, the model prediction compression uses the redundancy among multiple complete or predicted models for compression in one of the following ways: transmitting by using an overall residual between the deep neural network models to be transmitted and the deep neural network models of historical transmissions, or using the residuals of one or more layers of structures inside the deep neural network models to be transmitted, or using the residual measured by a convolution kernel.

Preferably, the model prediction compression includes deriving from one or more residual compression granularities or one or more data information and organization manner of the deep neural networks.

More preferably, the multiple models of historical transmissions of the receiving end are complete lossless models or lossy partial models.

Preferably, the quantizing manners include direct output of original data, or precision control of the weight to be transmitted, or the kmeans non-linear quantization algorithm.

Preferably, the multi-model prediction includes: replacing or accumulating the one or more originally stored deep neural network models.

Preferably, the multi-model prediction includes: simultaneously or non-simultaneously receiving one or more quantized predicted residuals, combined with the accumulation or replacement of part or all of the one or more originally stored deep neural networks.

According to an aspect of the present invention, a compression system for frequent transmission of deep neural networks is also provided, which includes:

a model prediction compression module which, based on one or more deep neural network models of this and historical transmissions, combines part or all of model differences between part or all of models to be transmitted and models of the historical transmissions to generate one or more predicted residuals, and transmits information required for relevant predictions; and

a model prediction decompression module which generates a received deep neural network based on the received one or more quantized predicted residuals and in combination with deep neural networks stored at a receiving end, including replacing or accumulating the originally stored deep neural network models;

wherein the model prediction compression module and the model prediction decompression module can add, delete and modify the deep neural network models of the historical transmissions and the stored deep neural networks.

The present invention has the following advantages: combined with the redundancy among multiple models of the deep neural networks under frequent transmission, the present invention uses the knowledge information among the deep neural networks for compression, and the size and bandwidth of the required transmission are reduced. Under the same bandwidth limitation, the deep neural networks can be better transmitted, and at the same time, it is possible to allow the deep neural networks to be performed a targeted compression at the front end, rather than being only partially restored after the deep neural networks are performed a targeted compression.

### BRIEF DESCRIPTION OF THE DRAWINGS

Upon reading a detailed description of preferred embodiments below, various other advantages and benefits will become clear to those skilled in the art. The drawings are merely used for the purpose of illustrating the preferred embodiments, and should not be considered as limiting the present invention. Moreover, throughout the drawings, identical reference signs are used to denote identical parts. In the drawings:

FIG. 1 shows a flowchart of an algorithm for traditional compression of deep neural networks;

FIG. 2 is a schematic compression flowchart showing applying the algorithm for traditional compression of deep neural networks to network transmission;

FIG. 3 shows a schematic compression flowchart of the transmission of deep neural networks over network according to the present invention;

FIG. 4 shows a schematic flowchart of the compression method for frequent transmission of deep neural networks proposed by the present invention;

FIG. 5 shows a schematic flowchart of frequent transmission and compression of deep neural networks in the case of considering transmission of preliminarily compressed deep neural network models;

FIG. 6 shows a flowchart of compressing deep neural networks under frequent transmission conditions provided by the present invention; and

FIG. 7 shows the principle diagram of the multi-model prediction module proposed by the present invention after considering the potential redundancy among deep neural network models for compression.

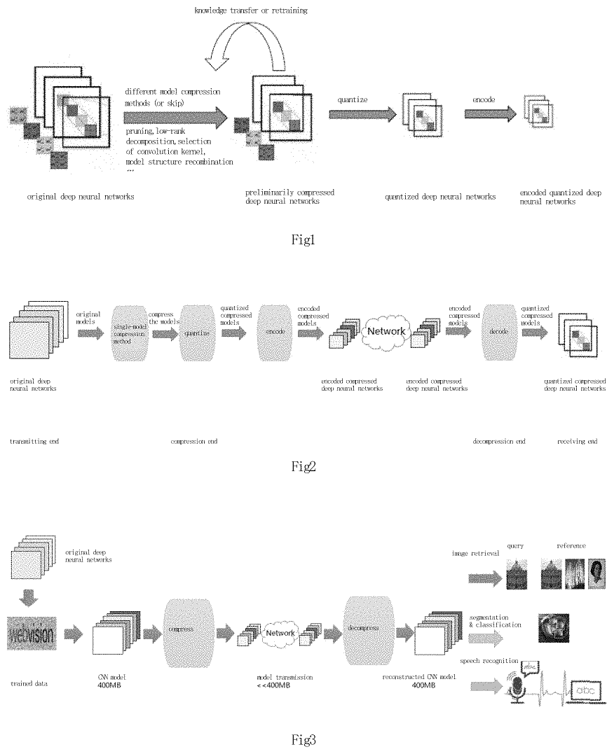

### DETAILED DESCRIPTION

Hereinafter, exemplary embodiments of the present disclosure will be described in more detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure to those skilled in the art.

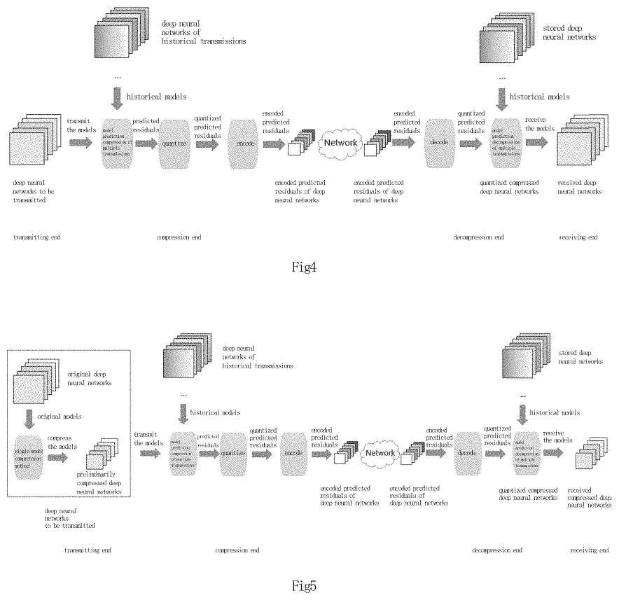

FIG. 3 shows a schematic compression flowchart of the transmission of deep neural networks over network according to the present invention. Based on one or more deep neural network models of this and historical transmissions, part or all of model differences between part or all of models to be transmitted and models of the historical transmissions are combined to generate one or more predicted residuals, and information required for relevant predictions is transmitted. Based on the received one or more quantized predicted residuals and in combination with deep neural networks stored at a receiving end, including replacing or accumulating the originally stored deep neural network models, a received deep neural network is generated.

As shown in FIG. 3, under the condition of a given bandwidth, the deep neural network is transmitted to the end to be transmitted in a lossy or lossless way. The deep neural network to be transmitted is compressed, and the compressed data is transmitted. The size of the compressed data is based on bandwidth conditions, and is less or much less than the original model. For example, the CNN model before compression is 400 MB, and the compressed data transmitted by the model is much less than 400 MB. The model is decompressed and restored to the lossy or lossless initial transmission model at the receiving end, which is then used for different tasks. For example, after the decompression, the reconstructed CNN model is still 400 MB, and this model is used for image retrieval, segmentation and/or classification tasks, speech recognition, etc.

FIG. 4 shows a schematic flowchart of the compression method for frequent transmission of deep neural networks proposed by the present invention. As shown in FIG. 4, in combination with the section “SUMMARY”, a feasible algorithm for multi-transmission model prediction is given, but the present invention is not limited to this.

For example, a VGG-16-retrain model needs to be transmitted, and both the receiving end and the transmitting end have the last transmitted model, such as original-vgg-16. Based on the present invention, there is no need to directly transmit the original model to be transmitted, namely, VGG-16-retrain. Through parameter residuals of each layer, a band transmission model with a smaller data range and less amount of information can be obtained. Likewise, taking the convolutional layer of the same-sized convolution kernel of the deep neural network as the basic unit, one base convolution layer can be used as the compression base of the same-sized convolution kernel, and in combination with the data distribution, a network layer with residuals to be transmitted and smaller data distribution may be obtained. Similarly, one or more convolution kernels can be used as the compression base, and for the VGG-16-ratrain to be transmitted, each convolution kernel of each convolution layer is subjected to compression methods such as residual compression or quantization to finally generate a predicted residual.

As compared with direct transmission, the redundancy among multiple models is used and combined to be compressed, and finally a predicted residual with a relatively small amount of information is generated, which when combined with a lossless predicted residual, can theoretically restore the original network losslessly, while generating fewer bandwidth and data requirements at the same time. By combining different network structures and multiple prediction models and selecting the appropriate prediction model and prediction structure, a predicted residual with a higher compression rate can be obtained, and the information required for relevant predictions is transmitted at the same time.

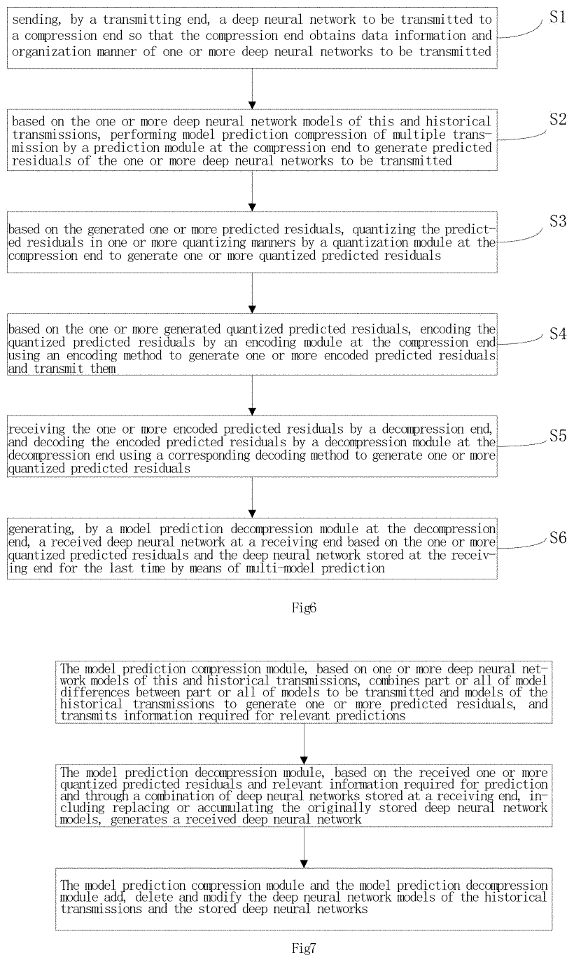

Traditional compression methods focus on the specialized compression of deep neural networks under a given task, but from the perspective of transmission, a broad and non-targeted compression method needs to be adopted. The traditional methods can solve the bandwidth problem to a certain extent, but they essentially produce a preliminary compression model, and then do not combine the historical deep neural network information; namely, there is a large redundancy among the models. That is, the preliminarily compressed deep neural network model (uncoded) is transmitted, as shown in FIG. 5; the present invention can also use the redundancy among different preliminarily compressed deep neural networks or the redundancy among uncompressed networks so that the compression rate is made higher in the transmission stage and the transmission bandwidth is saved.

As shown in FIG. 6, in a first aspect, the present invention provides a flowchart of compressing deep neural networks under frequent transmission conditions, which specifically includes the following steps:

S1: sending, by a transmitting end, a deep neural network to be transmitted to a compression end so that the compression end obtains data information and organization manner of one or more deep neural networks to be transmitted; wherein the data information and organization manner of the deep neural networks include the data and network structure of part or all of the deep neural networks, so one neural network to be transmitted can form the data information and organization manner of one or more deep neural networks.

S2: based on the one or more deep neural network models of this and historical transmissions, performing model prediction compression of multiple transmissions by a prediction module at the compression end to generate predicted residuals of the one or more deep neural networks to be transmitted.

In an environment where the compression end is based on frequent transmission, the data information and organization manner of one or more deep neural network models of the historical transmissions of the corresponding receiving end can be obtained; and if there is no deep neural network model of the historical transmissions, an empty model may be set as a default historical transmission model.

Model prediction compression is an algorithm module that combines the compression between this transmission and the multiple models of the historical transmissions of the corresponding receiving end, including but not limited to transmitting by using an overall residual between the deep neural network model to be transmitted and the deep neural network models of historical transmissions, or using the residuals of one or more layers of structures inside the deep neural network model to be transmitted, or using the residual measured by different units such as the convolution kernel. Finally, in combination with different multi-model compression granularities, predicted residuals of one or more deep neural networks are generated.

The compression of one or more model predictions includes but is not limited to deriving from one or more residual compression granularities or one or more data information and organization manner of the deep neural networks.

The multiple models of the historical transmissions of the receiving end may be complete lossless models, or lossy partial models, either of which will not affect the calculation of the redundancy among multiple models. Filling blanks or other methods can make up for it, or an appropriate representation method of the deep neural network models may be adopted for unification.

After the residual is calculated, it can be directly output or a feasible compression algorithm can be adopted to compress the predicted residual to control the transmission size.

S3: based on the generated one or more predicted residuals, quantizing the predicted residuals by a quantization module at the compression end in one or more quantizing manners to generate one or more quantized predicted residuals.

The quantizing manners include the direct output of the original data, that is, without quantization.

Quantization refers to controlling the transmission size for one or more received predicted residuals by using algorithms such as but not limited to: precision control of the weight to be transmitted (such as limiting a 32-bit floating point to a n-bit decimal, or converting it into 2ⁿ times, etc.), or using non-linear quantization algorithms such as kmeans to generate one or more quantized predicted residuals.

For one predicted residual, one or more iteratively transmitted quantized predicted residuals can be generated for different needs, such as 32-bit floating point data, which can be quantized into three groups of 8-bit quantized predicted residuals. For different needs, all or only part of the one or more quantized predicted residuals are transmitted.

Therefore, one or more quantized predicted residuals are finally generated.

S4: based on the one or more generated quantized predicted residuals, encoding the quantized predicted residuals by an encoding module at the compression end using an encoding method to generate one or more encoded predicted residuals and transmit them.

In the encoding module, one or more encoding methods can be used to encode the one or more quantized predicted residuals and transmit them. Then, they are converted into a bit stream which is sent to the network for transmission.

S5: receiving the one or more encoded predicted residuals by a decompression end, and decoding the encoded predicted residuals by a decompression module at the decompression end using a corresponding decoding method to generate one or more quantized predicted residuals.

In the decompression module, one or more decoding methods corresponding to the encoding end can be used to decode the one or more encoded predicted residuals to generate one or more quantized predicted residuals.

S6: generating, by a model prediction decompression module at the decompression end, a received deep neural network at the receiving end based on the one or more quantized predicted residuals and the deep neural network stored at the receiving end for the last time by means of multi-model prediction.

In the model prediction decompression module, based on the received one or more quantized predicted residuals and in combination with the deep neural networks stored at the receiving end, including replacing or accumulating the originally stored one or more deep neural network models, etc., a received deep neural network is generated.

In the model prediction decompression module, the one or more quantized predicted residuals can be received simultaneously or non-simultaneously, and in combination with partial or complete accumulation or replacement of the originally stored one or more deep neural networks, the received deep neural network is finally generated through one organization manner, and the transmission is completed.

As shown in FIG. 7, in a second aspect, the present invention proposes a multi-model prediction module after considering the potential redundancy among deep neural network models for compression, wherein the multi-model prediction module includes a compression module and a decompression module, and “useless” deep neural network information stored historically are utilized at compression and decompression ends.

1: The model prediction compression module, based on one or more deep neural network models of this and historical transmissions, combines part or all of model differences between part or all of models to be transmitted and models of the historical transmissions to generate one or more predicted residuals, and transmits information required for relevant predictions.

2: The model prediction decompression module generates a received deep neural network based on the received one or more quantized predicted residuals and in combination with deep neural networks stored at a receiving end, including replacing or accumulating the originally stored deep neural network models.

3: The model prediction compression module and the model prediction decompression module add, delete and modify the deep neural network models of the historical transmissions and the stored deep neural networks.

Through the above method and system, combined with the redundancy among multiple models of the deep neural networks under frequent transmission, the present invention uses the knowledge information among the deep neural networks for compression, and the size and bandwidth of the required transmission are reduced. Under the same bandwidth limitation, the deep neural networks can be better transmitted, and at the same time, it is possible to allow the deep neural networks to be performed a targeted compression at the front end, rather than being only partially restored after the deep neural networks are performed a targeted compression.

It should be noted:

The algorithms and displays provided herein are not inherently related to any particular computer, virtual device or other apparatus. Various general-purpose devices may also be used with the teaching based on the present invention. From the above description, the structure required to construct this type of device is obvious. In addition, the present invention is not directed to any specific programming language. It should be understood that various programming languages can be used to implement the content of the present invention described herein, and the above description of a specific language is to disclose the best embodiment of the present invention.

In the description provided herein, a lot of specific details are explained. However, it can be understood that the embodiments of the present invention may be practiced without these specific details. In some instances, well-known methods, structures and technologies are not shown in detail, so as not to obscure the understanding of the description.

Similarly, it should be understood that in order to simplify the present disclosure and help understand one or more of the various inventive aspects, in the above description of the exemplary embodiments of the present invention, the various features of the present invention are sometimes grouped together into a single embodiment, figure, or its description. However, the disclosed method should not be interpreted as reflecting the intention that the claimed invention requires more features than those explicitly recorded in each claim. More precisely, as reflected in the appended claims, the inventive aspects lie in less than all the features of a single embodiment disclosed previously. Therefore, the claims following the specific embodiment are thus explicitly incorporated into the specific embodiment, wherein each claim itself serves as a separate embodiment of the present invention.

It can be understood by those skilled in the art that it is possible to adaptively change the modules in the device in the embodiment and provide them in one or more devices different from the embodiment. The modules or units or components in the embodiments can be combined into one module or unit or component, and in addition, they can be divided into multiple sub-modules or sub-units or sub-components. Except that at least some of such features and/or processes or units are mutually exclusive, any combination can be used to combine all the features disclosed in the description (including the appended claims, abstract and drawings) and all the processes or units of any method or device so disclosed. Unless explicitly stated otherwise, each feature disclosed in the description (including the appended claims, abstract and drawings) may be replaced with an alternative feature providing the same, equivalent or similar purpose.

In addition, it can be understood by those skilled in the art that although some embodiments described herein include certain features included in other embodiments rather than other features, combinations of features of different embodiments means that they are within the scope of the present invention and form different embodiments. For example, in the appended claims, any one of the claimed embodiments may be used in any combination.

The various component embodiments of the present invention may be implemented by hardware, or by software modules running on one or more processors, or by a combination of them. Those skilled in the art should understand that a microprocessor or a digital signal processor (DSP) may be used in practice to implement some or all of the functions of some or all components in the virtual machine creation device according to the embodiment of the present invention. The present invention can also be implemented as a device or device program (for example, a computer program and a computer program product) for executing part or all of the methods described herein. Such a program for implementing the present invention may be stored on a computer-readable medium, or may have the form of one or more signals. Such signals may be downloaded from Internet websites, or provided on carrier signals, or provided in any other form.

It should be noted that the above-mentioned embodiments illustrate rather than limit the present invention, and those skilled in the art can design alternative embodiments without departing from the scope of the appended claims. In the claims, any reference signs placed between parentheses should not be constructed as a limitation to the claims. The word “include” does not exclude the presence of elements or steps not listed in the claims. The word “a” or “an” preceding an element does not exclude the presence of multiple such elements. The present invention can be implemented by means of hardware including several different elements and by means of a suitably programmed computer. In the unit claims enumerating several devices, several of these devices may be embodied by the same hardware item. The use of the words “first”, “second”, and “third” does not indicate any order. These words may be interpreted as names.

Described above are only specific preferred embodiments of the present invention, but the scope of protection of the present invention is not limited thereto. Any person skilled in the art can easily think of changes or replacements within the technical scope disclosed by the present invention, which shall all be covered within the scope of protection of the present invention. Therefore, the scope of protection of the present invention should be accorded with the scope of protection of the claims.

1. A compression method for frequent transmission of a deep neural network, comprising:
based on one or more deep neural network models of this and historical transmissions, combining part or all of model differences between part or all of models to be transmitted and models of the historical transmissions to generate one or more predicted residuals, and transmitting information required for relevant predictions; and
generating a received deep neural network based on the received one or more quantized predicted residuals and in combination with deep neural networks stored at a receiving end, comprising replacing or accumulating the originally stored deep neural network models.

2. The method according to claim 1, further comprising:
sending, by a transmitting end, a deep neural network to be transmitted to a compression end so that the compression end obtains data information and organization manner of one or more deep neural networks to be transmitted;
based on the one or more deep neural network models of this and historical transmissions, performing model prediction compression of multiple transmissions by a prediction module at the compression end to generate predicted residuals of the one or more deep neural networks to be transmitted;
based on the generated one or more predicted residuals, quantizing the predicted residuals by a quantization module at the compression end in one or more quantizing manners to generate one or more quantized predicted residuals;
based on the one or more generated quantized predicted residuals, encoding the quantized predicted residuals by an encoding module at the compression end using an encoding method to generate one or more encoded predicted residuals and transmit them;
receiving the one or more encoded predicted residuals by a decompression end, and decoding the encoded predicted residuals by a decompression module at the decompression end using a corresponding decoding method to generate one or more quantized predicted residuals; and
generating, by a model prediction decompression module at the decompression end, a received deep neural network at the receiving end based on the one or more quantized predicted residuals and the deep neural network stored at the receiving end for the last time by means of multi-model prediction.

3. The method according to claim 2, wherein the data information and organization manner of the deep neural networks comprise data and network structure of part or all of the deep neural networks.

4. The method according to claim 2, wherein in an environment where the compression end is based on frequent transmission, the data information and organization manner of the one or more deep neural network models of the historical transmissions of the corresponding receiving end can be obtained; and if there is no deep neural network model of the historical transmissions, an empty model is set as a default historical transmission model.

5. The method according to claim 2, wherein the model prediction compression uses the redundancy among multiple complete or predicted models for compression.

6. The method according to claim 5, wherein the model prediction compression is performed in one of the following ways: transmitting by using an overall residual between the deep neural network models to be transmitted and the deep neural network models of historical transmissions, or using the residuals of one or more layers of structures inside the deep neural network models to be transmitted, or using the residual measured by a convolution kernel.

7. The method according to claim 2, wherein the model prediction compression comprises deriving from one or more residual compression granularities or one or more data information and organization manner of the deep neural networks.

8. The method according to claim 4, wherein the multiple models of historical transmissions of the receiving end are complete lossless models and/or lossy partial models.

9. The method according to claim 2, wherein the quantizing manners comprise direct output of original data, or precision control of the weight to be transmitted, or the kmeans non-linear quantization algorithm.

10. The method according to claim 2, wherein the multi-model prediction comprises: replacing or accumulating the one or more originally stored deep neural network models.

11. The method according to claim 2, wherein the multi-model prediction comprises: simultaneously or non-simultaneously receiving one or more quantized predicted residuals, combined with the accumulation or replacement of part or all of the one or more originally stored deep neural networks.

12. A compression system for frequent transmission of deep neural networks, comprising:
a model prediction compression module which, based on one or more deep neural network models of this and historical transmissions, combines part or all of model differences between part or all of models to be transmitted and models of the historical transmissions to generate one or more predicted residuals, and transmits information required for relevant predictions; and
a model prediction decompression module which generates a received deep neural network based on the received one or more quantized predicted residuals and in combination with deep neural networks stored at a receiving end, comprising replacing or accumulating the originally stored deep neural network models.

13. The system according to claim 12, wherein the model prediction compression module and the model prediction decompression module can add, delete and modify the deep neural network models of the historical transmissions and the stored deep neural networks.
